(19) United States
(12) Patent Application Publication
(10) Pub. No.: US 2013/0048829 A1
(43) Pub. Date: Feb. 28, 2013

(54) SOLAR CONCENTRATOR POSITIONING SYSTEM AND METHOD

(71) Applicant: Edward Herniak, Amherst (CA)

(72) Inventor: Edward Herniak, Amherst (CA)

(21) Appl. No.: 13/510,857

(22) PCT Filed: Nov. 10, 2010
(86) PCT No.: PCT/CA10/01796

§ 371 Date: Aug. 16, 2012

Related U.S. Application Data
(60) Provisional application No. 61/259,747, filed on Nov. 10, 2009.

(51) Int. Cl. G01J 1/32; G02B 7/198

(52) U.S. Cl. 250/203.4; 359/872

(57) ABSTRACT

A system for configuring a solar concentrator has a parabolic solar concentrator that is moved by a mechanical alignment system for aligning the concentrator relative to the sun. A GPS receiver receives GPS signals and extracts a local time value for use in calculating the sun's position. An optical encoder provides a position of the solar concentrator relative to a known reference point, and a calibration circuit returns the parabolic solar concentrator to the known reference point at intervals in order to reduce effects of cumulative error within the optical encoder. A processor determines a position of the sun based on the local time value, and determines an adjustment for moving the solar concentrator from a current position thereof into an aligned condition with the sun. A signal is provided from the processor to a controller for moving the solar concentrator into the aligned condition.

This application claims the benefit of the U.S. Provisional Application 61/259,747 filed on Nov. 10, 2009, the entire contents of which are incorporated herein by reference.

### FIELD OF THE INVENTION

The invention relates to solar power and more particularly to a method and system for aligning a solar concentrator with the sun.

### BACKGROUND OF THE INVENTION

A known method of solar power generation involves concentrating the sun's light in order to increase the sunlight per unit of area. For example, sunlight is concentrated onto a photovoltaic cell or onto a tube to be heated. In either case, the concentrated sunlight greatly reduces the area of the photovoltaic cell or of the tube to be heated.

When concentrating sunlight, it is advantageous that the concentrator is pointed in a specific orientation relative to the sun. Unfortunately, the sun moves relative to terrestrial locations on a constant basis requiring a solar concentrator alignment system.

Two types of solar concentrator alignment systems are common. In a first type of system, astronomical charts are used to determine the sun's position and the solar concentrator is positioned relative to the known location of the sun. To this end, the mechanical workings of the alignment system are extremely accurate in order to move the solar concentrator to its intended position every time. This greatly increases the overall cost of the solar concentrator system. One method to overcome this cost increase is to use a parabolic reflector that is trough like in order to only have to align the concentrator in a single axis. This is useful when a tube containing fluid is to be heated since the focal point of the concentrator can be directed onto the tube regardless of the sun's “height” in the sky. Alternatively, an expensive two dimensional alignment mechanism is used. Further alternatively, errors in concentrator positioning are acceptable resulting in significant inefficiencies at times.

Problematically, systems based on known or calculated solar positioning are difficult to install and set up since they require an exact knowledge of a relative location and angle between the solar concentrator and the sun. Thus installation and set up of such a system is costly and requires skilled installers. Further, improper installation results in poor functioning of the system.

In a second type of system, sunlight is detected by a detector and the solar concentrator is moved to optimize its position relative to the sun. With feedback from the detector, it is possible to use lower cost alignment mechanics since the system is somewhat self-correcting. Problematically, most systems using feedback require a significant degree of initial alignment for the feedback system to work. It is also known to use a hybrid of the two approaches where the solar concentrator is aligned approximately using a known position of the sun and is then optimized using a feedback based alignment system.

Feedback based systems typically suffer known drawbacks over time. Sensors need to cleaned or maintained, and when the sensor fails or is dirty, misalignment of the solar concentrator often results.

It would therefore be beneficial to overcome at least some of the aforementioned drawbacks to the prior art.

### SUMMARY OF EMBODIMENTS OF THE INVENTION

In accordance with an aspect of the invention there is provided a system comprising: a parabolic solar concentrator; a mechanical alignment system for aligning the parabolic solar concentrator relative to the sun; a GPS receiver for receiving GPS signals and for extracting a local time value therefrom; an optical encoder for providing a relative position of the solar concentrator relative to a known reference point; a calibration circuit for returning the solar concentrator to the known reference point at intervals to reduce effects of cumulative error within the optical encoder; a processor for determining a first position of the sun based on the local time value and for determining a second position of the solar concentrator wherein it is in alignment with the sun at the first location based on the first position and the known reference point; and, a controller for directing the mechanical alignment system to move the solar concentrator to the second position.

In accordance with another aspect of the embodiment of the invention there is provided a method comprising: providing a solar concentrator having a parabolic reflector and a mechanism for moving the parabolic reflector about each of at least two axes; determining for the solar concentrator a reference position relative to something external to the solar concentrator; determining a local time; determining a position of the sun relative to the parabolic reflector based on the local time and the reference position; moving the parabolic reflector to align same for concentrating the sun's light; and at intervals moving the solar concentrator to the reference position for recalibration thereof.

In accordance with another embodiment of the invention there is provided a method comprising: providing a solar concentrator having a parabolic reflector and a mechanism for moving the parabolic reflector about each of at least two axes; determining for the solar concentrator a first position wherein the parabolic reflector is directed toward the sun; determining a local time; determining for the parabolic reflector a first reference position relative to something external to the solar concentrator; and determining an indicia indicative of when the parabolic reflector is in the first reference position, the indicia for use in self calibrating the solar concentrator mechanism.

### BRIEF DESCRIPTION OF THE DRAWINGS

Exemplary embodiments of the invention will now be described in conjunction with the following drawings, in which:

FIG. 1 is a simplified block diagram of a system according to an embodiment of the invention;

FIG. 2 is a simplified flow diagram of a method of setting up the system of FIG. 1; and

FIG. 3 is a simplified flow diagram of a method of aligning a parabolic reflector relative to the sun.

### DETAILED DESCRIPTION OF EMBODIMENTS OF THE INVENTION

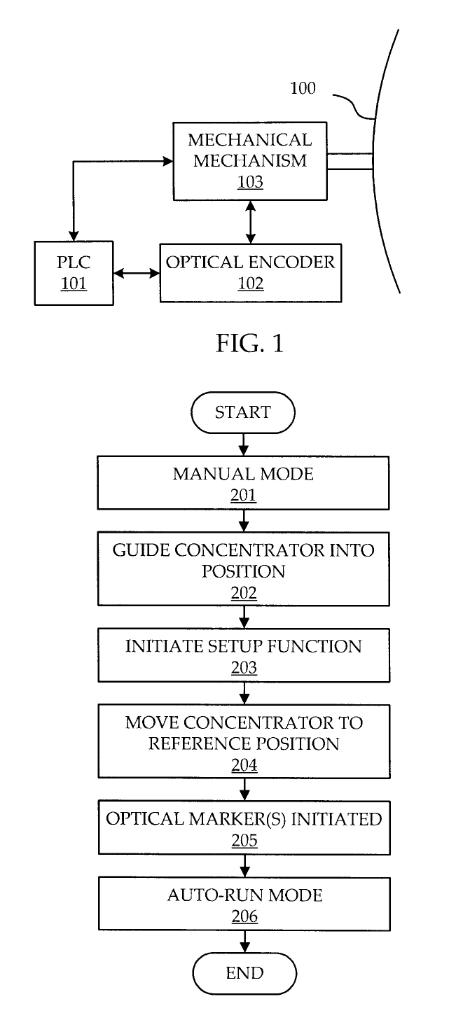

Referring to FIG. 1, shown is a simplified block diagram of a system according to an embodiment of the present invention. The system comprises a solar concentrator 100. The solar concentrator has a parabolic reflector that enables it to concentrate the sun's energy into a focal point where the solar collector is positioned. In addition, the solar concentrator is equipped with a dual axis celestial tracking system for tracking the sun during its operation. For example, a solar concentrator such as the Solartron Energy Systems Inc. SolarBeam—3.8-34000 can be used.

The system further comprises at least a Programmable Logic Controller (PLC) 101, at least an optical encoder 102 and a mechanical mechanism 103 for aligning a solar concentrator in horizontal and vertical directions. For example, the SolarBeam comprises a vertical axis motor: 24 W, 2 A and a horizontal axis motor: 12 W, 0.5 A.

The PLC performs a series of mathematical calculations to determine the solar position relative to the solar concentrator. Alternatively, the PLC relies on a look up table. Further, the PLC has a built in self-calibrating mechanism for execution, for example at the end of its daily operation. The self-calibration is achieved, for example, by means of a horizontal and a vertical reference position value which is determined during a prior set up procedure.

The mathematical calculations or the look up table access is based on a local time of the solar concentrator which is extracted from a GPS clock synchronization. This ensures that there is no cumulative time based error in sun tracking. The self-calibration ensures that any cumulative mechanical alignment error is limited to being within a period of time between self-calibration processes.

Referring to FIG. 2, a simplified flow diagram of an exemplary method of setting up a system according to the present embodiment is shown. The system is installed with a relatively stable base. For example a concrete base is installed for preventing shifting and moving of the solar concentrator. The system is set to a manual mode of operation at 201. Within the manual mode of operation, the operator guides the solar concentrator into position where the sun is concentrated into the center of the heat exchanger or onto the Photovoltaic module at 202. For example, this is done with the aid of an alignment tool. Optionally, the alignment tool is an optical alignment tool. Further optionally, the alignment tool is similar to the prior art feedback based alignment system. Further optionally, the alignment is done manually through visual or other inspection. Once the solar concentrator is aligned correctly at 202, the operator initiates a setup function at 203 that causes the PLC to calculate a current solar position based on a current time. This operation involves extracting a current time form one or more GPS signals and then calculating the position of the sun based on the time extracted. At 204, the operator moves the dish horizontally (eg. 60 deg) and vertically (eg. 5 deg) to a reference position where optical marker(s) are initiated at 205. For example, when optical marker(s) are already present on the device, the optical markers are recognized. When an optical encoder is used comprising a wheel with optical markings thereon, the reference position is used as a reference point for the optical encoders. Further optionally, the device self-marks or the user marks the reference position once it is determined. Once the PLC recognizes the markers, the PLC is set to the auto-run mode at 206.

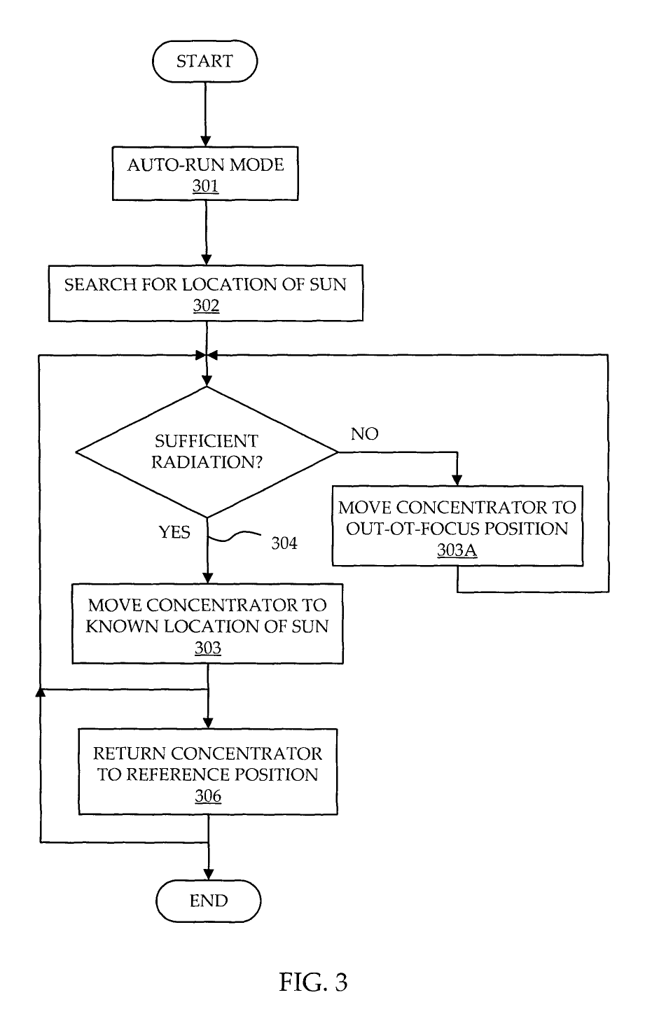

Referring to FIG. 3, shown is a simplified flow diagram of the system, once set up, in use. The PLC is set to the auto-run mode at 301. At 302, the system automatically searches for the sun's location. This is performed by knowing where the sun is at the present time and in reference to the known reference location(s). At 303, the solar concentrator is moved to the known location. However, when sun radiation is below a threshold value, for example 200 W/m2, at 303a, the system moves the solar concentrator to out of focus position (e.g. 90 deg or 5 deg) and it stops tracking the sun until the minimum sun level is met. This feature saves energy and protects the solar concentrator from being exposed to high winds from hurricanes and tornados. Once sunlight returns to sufficient levels at 304, the solar concentrator again tracks the sun at 303.

When the day is completed, the alignment mechanism returns to a reference position, the position where the optical marker(s) were set, at 306 to establish that it is in a known reference location. Thus, any error in alignment that occurs during the day does not affect a subsequent day's operation. Alternatively, the solar concentrator returns to the reference position numerous times during a same day.

Optionally, in addition to the low light conditions, the system forces the solar concentrator to go to an out of alignment position under one or more of the following situations: power failure; high temperature of the primary loop cooling system; high temperature of the secondary loop cooling system; high temperature of the heat exchanger/photovoltaic module; interruption of signals from the temperature sensor; low primary coolant pressure; and no flow meter signal.

Optionally when the PLC malfunctions, the primary & secondary loop pump are turned on. This action prevents overheating the heat exchanger/photovoltaic module. In addition the horizontal and vertical motors are shut off by means of end switches.

Numerous other embodiments may be envisaged without departing from the spirit or scope of the invention.

1. A system comprising:
a parabolic solar concentrator;
a mechanical alignment system for aligning the parabolic solar concentrator relative to the sun;
a GPS receiver for receiving GPS signals and for extracting a local time value therefrom; an optical encoder for providing a relative position of the solar concentrator relative to a known reference point;
a calibration circuit for returning the solar concentrator to the known reference point at intervals to reduce effects of cumulative error within the optical encoder;
a processor for determining a first position of the sun based on the local time value and for determining a second position of the solar concentrator wherein it is in alignment with the sun at the first location based on the first position and the known reference point; and,
a controller for directing the mechanical alignment system to move the solar concentrator to the second position.

2. A system according to claim 1 wherein the known reference point is a reference point relative to something external to the system.

3. A system according to claim 1 wherein the known reference point is a point wherein the solar collector is directed in a predetermined direction relative to Earth.

4. A system according to claim 1 wherein the known reference point is a point wherein the solar collector is directed in a predetermined direction relative to its installation location on Earth.

5. A system according to claim 3 wherein the known reference point is marked by determining a pre-existing marking that is in alignment when the solar collector is directed in the predetermined direction.

6. A system according to claim 3 wherein the known reference point is marked by marking the system when the solar collector is directed in the predetermined direction, the marking positioned for being used to realign the solar collector directed in the predetermined direction.

7. A system according to claim 1 comprising a light detector for detecting a level of ambient light and wherein the controller is for providing a first tracking operation when the light detected is above a predetermined threshold brightness and second non-tracking operation when the light detected is below a predetermined threshold brightness.

8. A method comprising:
providing a solar concentrator having a parabolic reflector and a mechanism for moving the parabolic reflector about each of at least two axes;
determining for the solar concentrator a reference position relative to something external to the solar concentrator;
determining a local time;
determining a position of the sun relative to the parabolic reflector based on the local time and the reference position;
moving the parabolic reflector to align same for concentrating the sun's light; and,
at intervals moving the solar concentrator to the reference position for recalibration thereof.

9. A method according to claim 8 wherein a local time is determined from GPS signal data received at the solar concentrator.

10. A method according to claim 8 wherein the mechanism comprises an optical encoder for indicating a position of the parabolic reflector.

11. A method according to claim 8 wherein the reference position is determined by aligning the parabolic reflector with objective alignment criteria and determining a location of the parabolic reflector when so aligned.

12. A method according to claim 10 wherein the reference position is counted from by the optical encoder.

13. A method according to claim 8 wherein the reference position is marked.

14. A method according to claim 11 wherein the reference position is identified by pre-existing markings on the solar concentrator, the markings for self calibration selected when the parabolic reflector is aligned with the objective alignment criteria.

15. A method according to claim 8 comprising providing a first tracking operation when the light detected is above a predetermined threshold brightness and second non-tracking operation when the light detected is below a predetermined threshold brightness.

16. A method comprising:
providing a solar concentrator having a parabolic reflector and a mechanism for moving the parabolic reflector about each of at least two axes;
determining for the solar concentrator a first position wherein the parabolic reflector is directed toward the sun;
determining a local time;
determining for the parabolic reflector a first reference position relative to something external to the solar concentrator; and
determining an indicia indicative of when the parabolic reflector is in the first reference position, the indicia for use in self calibrating the solar concentrator mechanism.

17. A method according to claim 16 comprising:
then setting the solar concentrator into a mode to track the sun during daylight hours.
